(19) United States
(12) Patent Application Publication
(10) Pub. No.: US 2009/0199732 A1
(43) Pub. Date: Aug. 13, 2009

(54) CYLINDER FOR A PRINTING UNIT OF A PRINTING MACHINE AND METHOD FOR REPLACING A SLEEVE FOR SUCH THE CYLINDER

(75) Inventor: Stefan Beyersdorff, Steinen (DE)

Correspondence Address: VENABLE LLP, P.O. BOX 34385, WASHINGTON, DC, 20043-9998, US

(73) Assignee: Mueller Martini Holding AG, Hergiswil (CH)

(21) Appl. No.: 12/370,271

(22) Filed: Feb. 12, 2009

(30) Foreign Application Priority Data
Feb. 12, 2008 (EP) EP 08405036.8

(51) Int. Cl. B41F 13/10; B41F 13/20

(52) U.S. Cl. 101/375; 101/479

(57) ABSTRACT

A cylinder for a printing unit of a printing machine includes a hollow support shaft with first and second tensioning elements arranged thereon at a distance to each other. A replaceable printing sleeve is positioned on the support shaft. First and second force transfer elements respectively cooperate with the first and the second tensioning element for clamping down and releasing the printing sleeve. An operating mechanism is arranged on the inside of the hollow support shaft and is operatively connected to the two force transfer elements. The operating mechanism includes at least one energy-storage element for tightening and releasing the two tensioning elements.

### CROSS-REFERENCE TO RELATED APPLICATION

This application claims the priority of European Patent Application No. 08405036.8, filed on Feb. 12, 2008, the subject matter of which is incorporated herein by reference.

### BACKGROUND OF THE INVENTION

The invention relates to a cylinder for a printing unit of a printing machine, the cylinder having a support shaft with a first and a second tensioning element arranged thereon at a distance to each other, on which a replaceable printing sleeve is positioned with the aid of a first and a second force transfer element that respectively cooperates with the first and/or second tensioning element for clamping down and releasing the printing sleeve. The invention furthermore relates to a method for replacing a printing sleeve on such a cylinder.

In order to process successively following, different printing jobs, printing machines must be retrofitted accordingly by replacing the cylinders of the printing units. To avoid such an expensive replacement of the cylinders, the cylinders used nowadays are embodied as rotating support shafts forming cylinder cores, which are provided with printing sleeves that are mounted to be detachable on the cores and which support the printing form. With this so-called sleeve technology, the cylinder does not need to be removed for installing or removing the printing sleeves. Different operating widths and printing image lengths can thus be realized with comparative ease in the printing machine, using a single cylinder core and a number of different printing sleeves adapted thereto.

A cylinder of the aforementioned type is known from the Spanish patent document ES 1065654 U. The support shaft of this cylinder is provided at both ends with a shaft journal having a smaller diameter. A tensioning element is respectively fitted onto each shaft journal, which expands in radial direction when admitted with an axially effective force and thus secures the printing sleeve on the support shaft. To exert an axial force onto the tensioning elements, a separate tensioning nut is arranged on both sides on the shaft journal, wherein the axial movement of each of the tensioning elements is restricted toward the inside by a separate shaft collar. In order to securely attach such a printing sleeve to the support shaft and to maintain good printing quality, it is important to ensure a sufficient centering as well as a uniform torque transfer from the support shaft to the printing sleeve which, however, is very involved if a force must be exerted separately onto the tensioning elements and can hardly be automated.

The German patent document DE 19955084 A1 discloses a printing unit for producing different printing image lengths in offset printing, for which format components that are embodied as printing sleeves and have different diameters corresponding to the intended printing image length are pushed onto the cylinder cores of a full-rotation offset printing machine. The cylinder cores are positioned with their shaft ends on both sides inside the machine housing, wherein the drive side of the cylinder core is positioned cantilevered while the other side is provided with a bearing that can be removed from its support position and thus functions as the operating side for replacing the printing sleeve. When removing the bearing on the operating side, a corresponding opening is freed in the machine housing which can be used to replace the printing sleeve. To be able to expand the printing sleeves and push them onto the cylinder cores, the latter must be embodied as air shafts and the printing sleeves must be provided on the inside surfaces with a compressible layer. Compressible layers of this type, however, have the disadvantage that the printing sleeves are pushed out of their concentric position as a result of the high linear forces exerted during the offset printing, meaning the high forces for pressing the cylinder against the contact line, thereby resulting in changes to the adjustments and thus also to considerable problems during the printing operation.

A printing unit for the indirect printing is disclosed in the German patent document DE 19534651 A1, for which the printing sleeve is secured either by expanding the circumference of the cylinder core with the aid of a pressure device or by using conical ring-shaped tensioning elements arranged between the cylinder core and the printing sleeve. Ring-shaped tensioning elements of this type, however, do not have sufficient rotational accuracy and are relatively expensive to install/remove. On the other hand, cylinder cores with an expandable circumference of necessity have hollow spaces for a corresponding pressure medium. If the pressure of the medium drops, then the printing sleeve immediately detaches itself from the cylinder core, which can considerably interfere with the printing process. Cylinder cores of this type furthermore represent a compromise between the required rigidity and the deformability necessary for securing the printing sleeve.

The content disclosed in European patent document EP 1442883 A1 is directed toward a clamping cylinder used for the stamping technology, and a corresponding method for chucking cylindrical stamping dies for stamping rollers. The clamping cylinder comprises a drive shaft and a clamping sleeve that is clamped onto two outside positioned shaft sections of the drive shaft, respectively with the aid of separate fixation devices, wherein the clamping sleeve carries the tube-shaped stamping die which is also called a sleeve. The first fixation device is admitted axially on the outside by an adjustment screw while a spacer tube fits against it axially on the inside. On the other end, the spacer tube adjoins the second fixation device, which is delimited axially on the outside by a different shaft section with a larger diameter. During the axial compression caused by the adjustment screw and/or the spacer tube, the fixation devices expand in the radial direction and thus secure the clamping cylinder on the drive shaft, either with or without the stamping die. A temporary expansion with compressed air is used for fitting on the stamping die. The additional arrangement of a clamping sleeve and the necessary fitting on of the stamping die by using an air cushion, however, results in a relatively involved device and method. In addition, during the securing of the clamping sleeve, the first fixation device that is initially admitted directly by the adjustment screw is expanded in radial direction. As a result, the clamping sleeve is clamped to the drive shaft section, so that immediately thereafter the first fixation device is secured in axial direction and any further transfer of force to the second fixation device is impossible. The danger consequently exists that the clamping sleeve and thus the stamping die can only be securely mounted on one side, which accordingly hinders or even prevents a following stamping operation.

### SUMMARY OF THE INVENTION

It is an object of the present invention to provide a cylinder of the aforementioned type, which permits an easier and faster replacement of the printing sleeve while nevertheless ensuring a good printing quality. In particular, it should be easy to automate the operation of clamping down and releasing the printing sleeve. It is furthermore an object of the invention to specify corresponding methods for replacing printing sleeves.

The above and other object are achieved according to the invention by the provision of a cylinder for a printing unit of a printing machine, the cylinder comprising: a hollow support shaft; first and second tensioning elements positioned at a distance to each other on the hollow support shaft; a replaceable printing sleeve positioned on the support shaft; first and second force transfer elements that respectively operate jointly with the first and the second tensioning element for clamping on and releasing the printing sleeve; and an operating mechanism arranged inside the hollow support shaft and operatively connected to the first and second force transfer elements, wherein the operating mechanism includes at least one adjustable energy-storage element to tighten and release the first and second tensioning elements.

According to a modification of the invention, an adjustment element for the energy-storage element is connected to the operating mechanism. As a result, the forces generated by the rotational movement of a single operative element, meaning the adjustment element, can be transmitted uniformly to the two tensioning elements, either to secure the printing sleeve on the support shaft and/or to detach it from the shaft, depending on the type of force used for admitting the adjustment element.

If the support shaft and the printing sleeve are not clamped together, the two tensioning elements have a clearance fit to the support shaft and/or the printing sleeve along the inside and the outside diameter. The radial expansion of the two tensioning elements is increased if an axial force is exerted by the force-transfer elements, meaning their inside diameter is reduced and the outside diameter is increased. A frictional force is thus generated between the tensioning elements and the support shaft and/or the printing sleeve fitted onto the support shaft. In the process, the printing sleeve is securely clamped onto the support shaft.

In order to replace the printing sleeve, the drive for the cylinder is initially shut down and the adjustment element on the operating mechanism is then adjusted, meaning it is loosened enough to relax the energy-storage element as well as the tensioning elements. As a result, the frictional connection again becomes a clearance fit, thus making it easy to pull off the printing sleeve used until then and remove it through a corresponding opening in the housing of the printing unit, so that a different printing sleeve can be installed. Finally, the adjustment element is again adjusted correspondingly by tightening it on the operating mechanism, thereby also tightening the energy-storage element, the two tensioning elements and clamping the printing sleeve onto the support shaft.

In this way, the replacement of printing sleeves can be realized easily along with a secure fastening on the support shaft while simultaneously creating the precondition for a good printing quality. The rigidity of the drive shaft is furthermore not reduced by the components required for replacing the printing sleeve. As a result of using the energy-storage element, it is not necessary to feed energy from the outside into the system, either in the clamped or in the detached condition, so that the cylinder is intrinsically safe.

According to one embodiment of the invention, the operating mechanism is provided on the drive side or the operating side with an end section that projects from the support shaft, on which the adjustment element and the energy-storage element are arranged. A bushing is positioned on this end section, between the adjustment element and the energy-storage element, and a gliding bearing is arranged on the drive side of the bushing. A radial, axially extending elongated hole is provided in the bushing, in which engages a pin that is connected to the end section of the operating mechanism. The adjustment element is furthermore embodied as clamping nut and is arranged on an outside thread of the end section. With this arrangement and embodiment of the end section, it is advantageously possible to operate the adjustment element from one side only, which can be done manually or automatically. The embodiment and the arrangement of the bushing avoid a direct contact between the adjustment element and the energy-storage element, in particular if the operating mechanism is turned relative to the two tensioning elements for pre-tensioning the energy-storage element. Friction losses and signs of wear on the adjustment element or the energy-storage element can thus be reduced. Embodying the adjustment element as a clamping nut that is positioned on an outside thread of the end section provides an easy option for activating the adjustment element and thus for clamping on and/or releasing the printing sleeve on the support shaft.

According to a different embodiment of the invention, the support shaft is provided with respectively one extension, arranged between the drive side and/or the operating side shaft end as well as the cylinder, wherein the force transfer elements are arranged in a continuous recess in the extension. A separate strain washer is arranged between the force transfer element and the two tensioning elements, on the extension of the support shaft. The support shaft extension advantageously creates space for positioning the force transfer elements and the strain washers, wherein the latter uniformly distribute the force exerted by the force transfer elements to the two tensioning elements.

A different embodiment according to the invention provides for a radial clearance space to be formed on the drive side or the operating side end of the shaft, between the support shaft and the operating mechanism. An axially displaceable clamping sleeve is arranged in this clearance space, which is displaceable between the energy-storage element and a shoulder on the operating mechanism that is formed onto the other end of the clamping sleeve. This type of embodiment of the invention primarily has production-technical advantages as compared to a one-piece embodiment for the operating mechanism and the clamping sleeve.

The force transfer elements of a different embodiment of the invention are each provided with an inside bushing and an outside bushing that closes off the inside bushing in the radial direction toward the outside. The inside bushing is connected with the aid of fastening elements to the operating mechanism, and the operating mechanism is provided with through openings for the fastening elements. The clamping sleeve is provided in the area of the first force transfer element and the operating mechanism is provided in the area of the second force transfer element with a radially outward directed recess, into which projects the inside bushing for the respective force transfer element. As a result, the two tensioning elements can advantageously be admitted uniformly with a clamping force by activating a single adjustment element.

The adjustment element of yet another embodiment of the invention is embodied such that it can be secured on the operating mechanism to prevent axial movements, while the operating mechanism is connected to the support shaft so as to rotate along, wherein a drive shaft for the cylinder is arranged parallel to the support shaft inside the housing and is drive-connected to the support shaft. A holding element that can be pulled back is arranged on the printing unit housing, and a device for accommodating this holding element is arranged on the adjustment element. The accommodating device in this case consists of a number of pins arranged on an adjustment element surface, which faces the holding element, wherein the holding element is connected to and advantageously rests on a pneumatic cylinder.

A simple, low maintenance solution is thus provided for securing the adjustment element against rotation on the operating mechanism. With this arrangement, it is possible to define the direction of rotation and the amount of rotation for the support shaft during the clamping on of the printing sleeve. In the process, the forces resulting from the rotation of the support shaft are distributed uniformly to the two tensioning elements.

To describe the replacement of the printing sleeve in detail, the cylinder drive is first turned off and the adjustment element is then blocked against rotation on the operating mechanism. Following this, the cylinder drive is started up again and the support shaft and the operating mechanism are turned to release the tightening of the energy-storage element and the two tensioning elements, such that the fixed rotational connection between the printing sleeve and the support shaft is loosened. The cylinder drive is then turned off again, the printing sleeve is pulled from the support shaft and is removed through the opening in the print unit housing, and a different printing sleeve pulled on. The bearing plate is subsequently pivoted back to its starting position, meaning the opening is closed again. Following that, the cylinder drive is re-started, the support shaft and the operating mechanism are turned in a direction counter to the previously selected rotational direction and the energy-storage element along with the two tensioning elements and thus also the printing sleeve are clamped onto the support shaft. Finally, the cylinder drive is turned off once more and the blocking of the adjustment element released.

This partial process can advantageously be automated, owing to the fact that the printing sleeve is clamped down and removed with the aid of the drive shaft for the cylinder and the clamping force can also be adjusted via this drive shaft and via a thereto connected evaluation and control unit.

According to a different embodiment of the invention, the drive-side end of the support shaft is positioned cantilevered while the operating side end of the shaft is provided with a bearing that can be removed from the support position. The bearing with a bearing plate is supported in the housing, wherein the bearing plate is designed so as to pivot out of the housing and is provided with a pivot bearing.

According to a different embodiment of the invention, the printing sleeve comprises at each end respectively one integral support ring, and the two tensioning elements are arranged between the support shaft and the respective support ring. Installation recesses are formed into the two support rings. It is particularly advantageous if at least one further support element is arranged on the cylinder inside and a centering sleeve is arranged on the support shaft, between the two tensioning elements. A printing sleeve of this type, which is provided with support rings at the ends, is relatively resistant to twisting and can therefore be transported and replaced particularly easily. The installation recesses, the additional support element and the centering sleeve permit a secure handling of the printing sleeve during the replacement.

Finally, the energy-storage element is additionally provided with a set of spring washers.

### BRIEF DESCRIPTION OF THE DRAWINGS

These and other features and advantages of the invention will be further understood from the following detailed description of the preferred embodiments with reference to the accompanying drawings, showing in:

FIG. 1 is a partial, perspective representation of the printing unit with cylinder for an offset printing machine, during the replacement of the printing sleeve.

FIG. 2 is a side view of a section through the cylinder with clamped on printing sleeve.

FIG. 3 is an enlarged representation of the drive end region, according to FIG. 2.

FIG. 4 is an enlarged representation of the operating end region, according to FIG. 2.

### DETAILED DESCRIPTION

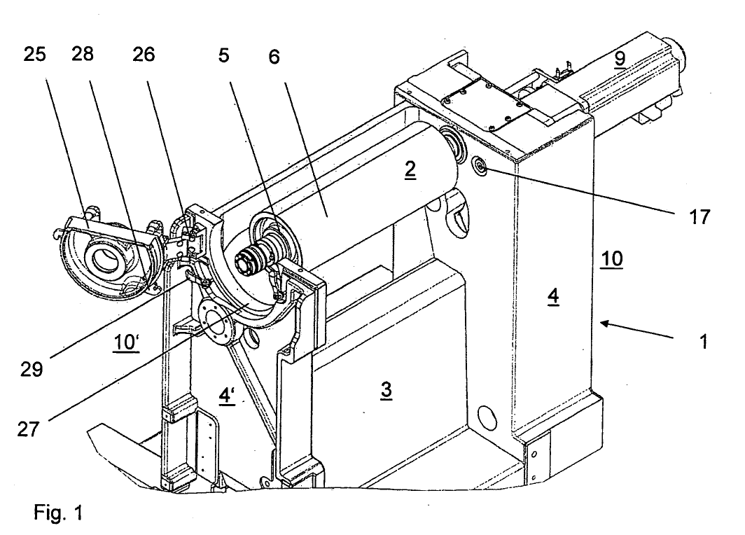

Referring to FIG. 1, there is shown a perspective view of an embodiment of a printing unit 1 for an offset printing machine, restricted to the components that are essential to understanding the invention. The printing unit 1 includes, among other things, a cylinder 2, wherein the illustrated embodiment shows a rubber-blanket cylinder. The printing unit includes a housing 3 with two side panels 4, 4′, designed for positioning the cylinder 2. Additional components that also belong to the printing unit 1, such as plate cylinders and counter-pressure cylinders as well as the ink and coloring units, have been omitted for reasons of clarity.

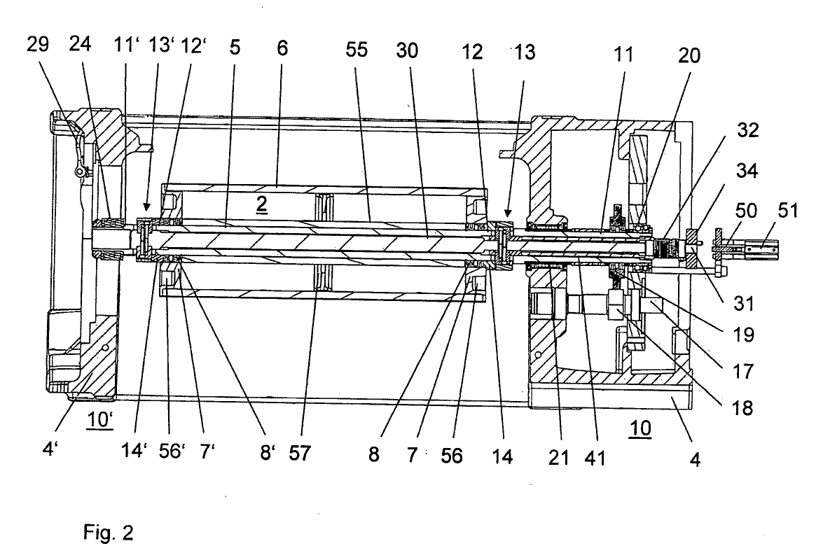

The cylinder 2 includes a cylinder core in the form of a support shaft 5, which is detachably connected to a format part embodied as printing sleeve 6. The printing sleeve 6 is provided on each end with respectively one integral support ring 7, 7′ which, in the fully assembled state, is clamped so as to rotate along with the support shaft 5 (see FIG. 2) with the aid of a first and/or a second tensioning element 8, 8′ that is embodied as a clamping bush and sits on the support shaft 5. In the non-tensioned state, the two tensioning elements 8, 8′ have a cylindrical outside and inside shape. One end of the support shaft 5 is connected to a drive 9 and is therefore called the drive end 10, while the other end of the support shaft 5 is at least temporarily accessible for operating and maintenance operations and is therefore called the operating end 10′ (FIG. 1).

As shown in FIG. 2, the support shaft 5 extends past the cylinder 2, meaning the cylinder is provided at the ends with a separate shaft end 11, 11′ embodied as a shaft pivot, as well as an axial extension 12, 12′ that is arranged between the cylinder 2 and the shaft end 11, 11′. A force transfer element 13, 13′ that is embodied as a driver is arranged on the drive side and on the operating side extension 12, 12′. The force transfer element acts in the axial direction upon the respective tensioning element 8, 8′ via separate strain washers 14, 14′ resting on the extensions 12, 12′.

Alternatively to arranging them on the extension 12, 12′, the force transfer elements 13, 13′ can also be arranged on the inside of the cylinder 2.

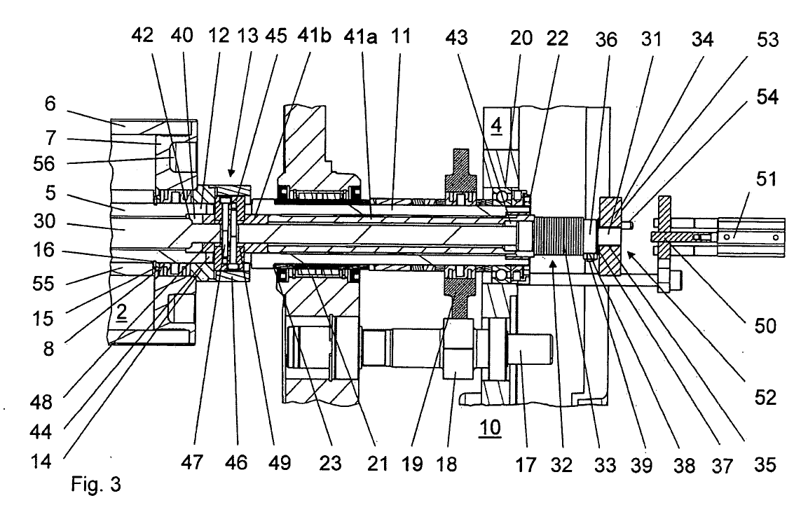

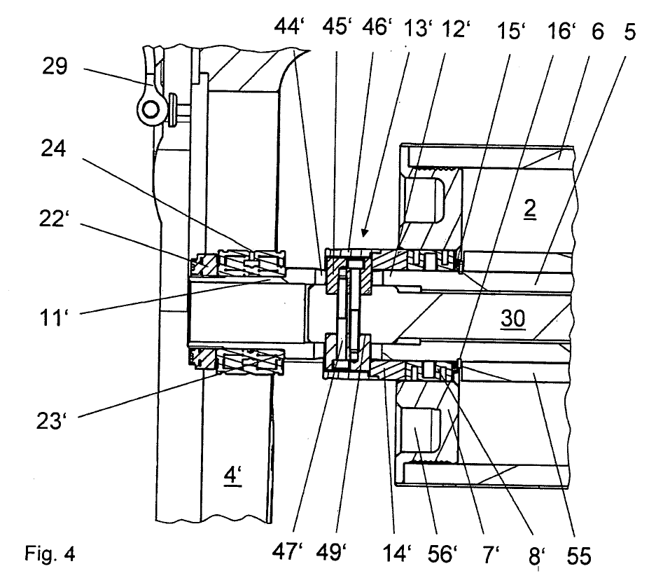

A separate spacer 15, 15′ is used to secure the tensioning elements 8, 8′ in the axial direction toward the inside, wherein this spacer is held in place by a corresponding safety ring 16, 16′ (see FIGS. 3, 4).

The cylinder 2 is driven by a drive shaft 17, arranged parallel to the support shaft 5, for which a pinion 18 that sits on the drive shaft 17 engages in a gearwheel 19, mounted on the drive-side shaft end 11, thus forming a single-stage spur gear (FIGS. 2, 3). The drive shaft 17 is furthermore connected to the drive 9 that is embodied as a motor (FIG. 1).

Two bearings 20, 21 that support the support shaft 5 in the side panel 4 are arranged on the drive-side shaft end 11, wherein these bearings are embodied as ball bearings and/or needle bearings. The bearing 20 is secured with a groove nut 22 on the drive-side shaft end 11, and the bearing 21 is secured by a shoulder 23, embodied on the shaft between the shaft end 11 and the extension 12 (FIG. 3). The operating-side shaft end 11′ has a bearing arrangement 24, which consists of two cylindrical roller bearings that support the shaft 5 in the side panel 4′ and is also secured in the axial direction with a groove nut 22′ and a shaft shoulder 23′ (FIG. 4). The operating-side bearing 24 and/or its bearing plate 25 are embodied so as to be removable from the support position, e.g. by pivoting it out. FIG. 1 shows the bearing plate 25 in the opened position where it is pivoted around a pivot bearing 26, thus freeing an opening 27 in the side panel 4′ which can be used to replace the printing sleeve 6. In this position, the cylinder 2 and/or its support shaft 5 is supported by the bearings 20, 21 only on one side in the housing 3, meaning it is positioned cantilevered. For opening and closing the bearing plate 25, the bearing plate is provided with holding elements 28 for accommodating corresponding locking elements 29 in the side panel 4′.

The support shaft 5, which is embodied as a hollow shaft, is provided on the inside with an operating mechanism 30 embodied as a pull rod, which is rotationally connected to the support shaft 5 and can be moved back and forth with limitations. The operating mechanism has an end section 31 that projects from the support shaft 5 on the drive-side end. An energy-storage element 32, comprising a set of spring washers 33 (FIG. 3), sits on the end section 31 of the operating mechanism 30. The energy-storage element 32 is held in place on the drive side by an adjustment element 34, embodied as tensioning nut, which in turn is arranged on an external thread 35 of the end section 31. The adjustment element 34 and the operating mechanism 30 are thus embodied to move relative to each other in axial direction. A different mechanical or pneumatic energy-storage element can also be used alternatively to the set of spring washers 33.

A bushing 36 is furthermore arranged on the end section 31, between the adjustment element 34 and the energy-storage element 32 while a sliding bearing 37 is arranged on the drive side of the bushing 36. The bushing 36 is provided with a radial, axially extending elongated hole 38, in which engages a pin 39 that is connected to the operating mechanism 30 and secures the bushing 36 against rotation. On the sliding surfaces of the sliding bearing 37, which are not shown in further detail herein, a relative movement occurs between the adjustment element 34, which is immovable during the tightening and releasing of the printing sleeve 6, and the bushing 36 that turns along with the operating mechanism 30. As a result, friction losses can be lowered and wear and tear reduced for the adjustment element 34 or on the energy-storage element 32.

In the region of the drive-side shaft end 11 and the extension 12, the support shaft 5 has a larger inside diameter and the operating mechanism 30 has a smaller outside diameter than is the case in the region of the cylinder 2. A radial clearance space 40 that is thus created on the drive side, between the support shaft 5 and the operating mechanism 30, houses a clamping sleeve 41 used for tightening the first tensioning element 8 on the drive side, which is arranged displaceable in axial direction between the energy-storage element 32 and the first tensioning element 8. The clamping sleeve 41 has a two-part design, meaning it consists of a first sleeve part 41a that follows the energy-storage element 32 and a second sleeve part 41b that is arranged in the area of the drive-side force transfer element 13. However, the sleeve can also have a one-part design. The second sleeve part 41b extends through the drive-side force transfer element 13 and into the remaining clearance space 40 on the drive side of a shoulder 42 of the operating mechanism 30. On the operating side for the energy-storage element 32, a centering sleeve 43 for the operating mechanism 30 is arranged between the clamping sleeve 41 and the operating mechanism 30.

The force transfer element 13 on the drive side is mounted in a continuous recess 44 in the extension 12 for the support shaft 5 and rests on the operating mechanism 30. The force transfer element 13 has a two-part design, meaning it has an inside bushing 45 and an outside bushing 46 that closes off the inside bushing in the radial direction toward the outside. The inside bushing 45 is connected to the operating mechanism 30 with fastening elements 47, embodied as screws, for which the operating mechanism 30 is provided with through openings 48 in the form of elongated holes for the fastening elements 47. The second sleeve part 41b is provided with a radially outward pointing recess 49, in which engages the inside bushing 45 of the drive side force transfer element 13. If a corresponding force is exerted by the energy-storage element 32 and the clamping sleeve 41, the inside bushing 45 of the drive-side force transfer element 13 is displaced axially toward the strain washer 14, so that this washer acts in axial direction upon the first tensioning element 8 on the drive side.

The force transfer element 13′ on the operating side is designed identical. However, its inside bushing 45′ rests in an outward pointing recess 49′ of the operating mechanism 30 and is admitted by it in axial direction (FIG. 4).

A holding element 50 that is embodied as a flat rod is attached to the drive-side panel 4 of the housing 3 and is designed such that it can be moved in the direction of the adjustment element 34 with the aid of a pneumatic cylinder 51. The adjustment element 34 is provided with a device 52 for accommodating the holding element 50, consisting of a surface 53 that faces the holding element 50 and several thereon arranged pins 54 (FIG. 3).

To replace the printing sleeve 6, the drive 9 for the cylinder 2 must first be shut down. Once the cylinder 2 is stopped, the holding element 50 is moved with the aid of the pneumatic cylinder 51 in the direction of the adjustment element 34, until it impacts with the surface 53 that faces it and engages in the pins 54.

Once the adjustment element 34 has been secured in this way against rotation, the drive 9 for the cylinder 2 is restarted. As a result, the support shaft 5 together with the operating mechanism 30 and the thereon arranged energy storage element 32 are turned by a defined amount with the aid of the drive shaft 17 and the spur gear, meaning the adjustment element 34 on the external thread 35 of the end section 31 is loosened and the energy-storage element 32 is loosened. In the process, the operating mechanism 30 is moved in the direction of the operating side 10′ while the clamping sleeve 41 is no longer admitted with a force in the direction of the operating side 10′ because the energy-storage element 32 is no longer tightened. The previously tight connection between the operating mechanism 30 and the clamping sleeve 41 is thus relaxed and the two force transfer elements 13, 13′ as well as the thereon positioned strain washers 14, 14′ are relieved of the load. The axial pressure exerted on the two tensioning elements 8, 8′ is stopped, so that their radial expansion is again reduced to the starting value and a clearance fit adjusts in place of the existing frictional fit between the printing sleeve 6 and/or its support rings 7, 7′ and the two tensioning elements 8, 8′, as well as between those and the support shaft 5.

Once the locking elements 29 are released from the holding elements 28, the bearing plate 25 is pivoted around its pivot journal 26. The opening 27 is thus freed and the printing sleeve 6 ready for replacement (FIG. 1). The sleeve is subsequently removed through the opening 27 and replaced with another printing sleeve 6 needed for the further printing operation. Following this, the bearing plate 25 is pivoted back to the starting position, meaning the opening 27 is closed once more. The actual pulling off and/or pulling on of the printing sleeve is done either manually or with an auxiliary device that is not shown herein. In the process, the outside bushing 46′ of the operating side force transfer element 13′ takes on a centering function for the printing sleeve 6. A centering sleeve 55 is furthermore arranged on the support shaft 5, between the two tensioning elements 8, 8′, while corresponding mounting recesses 56, 56′ are formed into the support rings 7, 7′. Finally, additional support elements 57 can be arranged on the inside of the cylinder 2 (FIG. 2).

The same steps are required for attaching a different printing sleeve 6 to the support shaft 5 as are required as for dismantling the previously used printing sleeve 6, only in opposite rotational direction for the drive shaft 17, the support shaft 5 and the operating mechanism 30. When turning the operating mechanism 30, it is moved in the direction of the adjustment device 34, arranged on the drive side, and the energy-storage element 32 is tensioned in the process. The energy-storage element 32, which is thus pre-tensioned, pushes the clamping sleeve 41 and/or its sleeve parts 41a, 41b in the direction of the operating side 10′, thus causing the inside bushing 45 of the force transfer element 13 to be admitted with a force in axial direction. This axial force is transmitted to the drive-side strain washer 14, which then exerts a force in axial direction onto the first, immovably installed tensioning element 8 on the operating side, causing this element to expand in radial direction and thus clamp the printing sleeve 6 onto the support shaft 5 on the drive side.

During the rotation of the support shaft 5 and thus also the operating mechanism 30, the second tensioning element 8′ on the operating side is admitted via the strain washer 14′ with a tensile force in axial direction, owing to the fact that the inside bushing 45′ of the operating side force transfer element 13′ is guided in the recess 49′ of the operating mechanism 30, and is thus compressed. As a result, the printing sleeve 6 is simultaneously clamped onto the support shaft 5 on the operating side as well as on the drive side. Finally, the drive 9 of the cylinder 2 is shut down and the blocking of the adjustment element 34 is released, whereupon the printing unit 1 is again operational.

The number of required rotations of the support shaft 5 and thus the operating mechanism 30 is clearly fixed and can be detected, for example, by evaluating a shaft encoder for the drive 9 or by evaluating the axial adjustment distance for the adjustment element 34, detected via inductive proximity sensors. The transmittable moment can in principle be increased optionally via the type of energy-storage element 32 that is used and the tightening moment for the adjustment element 34, as well as the dimensioning of the two tensioning elements 8, 8′.

The complete operation of clamping on and releasing the printing sleeve takes place automatically and is controlled and monitored with the aid of an evaluation and control unit that is not shown herein. For this, it is necessary to detect the position of the adjustment element 34 as previously mentioned. The position and existence of the printing sleeve 6 are also determined, either by also using a proximity sensor or with the aid of a high-frequency identification system (RFID=radio frequency identification). The latter can, of course, also be used to detect additional input variables for the control, for example the type of cylinder (e.g. a rubber-blanket cylinder, plate cylinder) or its diameter.

With a correspondingly reversed design for the support shaft 5, meaning if the end section 31 and thus the adjustment element 34 and the energy-storage element 32 are arranged on the operating side 10′, the clamping down or releasing of the printing sleeves 6 can also be handled directly by an operator. In that case, it is possible to omit the holding element 50 together with the pneumatic cylinder 51 and the respective device 52 on the adjustment element 34, as well as the above-described control. The number of required operating steps are furthermore reduced, so that following the shut-down of the drive 9 for the cylinder 2 and the opening of the printing unit 1, it is only necessary to loosen the adjustment element 34 on the operating mechanism 30 to relax the energy-storage element 32 and thus also the two tensioning elements 8, 8′. The printing sleeve 6 can then be pulled off the support shaft 5 and a different printing sleeve 6 can be pulled on. Finally, the adjustment element 34 is tightened once more on the operating mechanism 30, thereby also tightening the energy-storage element 32 and the two tensioning elements 8, 8′ and clamping the printing sleeve 6 onto the support shaft 5. Following the closing of the opening 27, the printing unit 1 is again ready for use.

It will be understood that the above description of the present invention is susceptible to various modifications, changes and adaptations, and the same are intended to be comprehended within the meaning and range of equivalents of the appended claims.

What is claimed is:

1. A cylinder for a printing unit of a printing machine, comprising:
a hollow support shaft;
first and second tensioning elements positioned at a distance to each other on the hollow support shaft;
a replaceable printing sleeve positioned on the support shaft;
first and second force transfer elements that respectively operate jointly with the first and the second tensioning element for clamping on and releasing the printing sleeve; and
an operating mechanism arranged inside the hollow support shaft and operatively connected to the first and second force transfer elements, wherein the operating mechanism includes at least one adjustable energy-storage element operatively arranged to tighten and release the first and second tensioning elements.

2. The cylinder according to claim 1, further including an adjustment element connected to the operating mechanism to adjust for the energy-storage element.

3. The cylinder according to claim 2, wherein the operating mechanism includes an end section projecting from the support shaft and the adjustment element is arranged on the end section.

4. The cylinder according to claim 3, wherein the energy-storage element is arranged on the end section, the cylinder further including:
a bushing arranged between the adjustment element and the energy-storage element; and
a sliding bearing arranged on a drive side of the bushing.

5. The cylinder according to claim 4, wherein the bushing includes a radial, axially extending elongated hole and the cylinder further includes a pin extending in the hole and being connected to the end section.

6. The cylinder according to claim 3, wherein the adjustment element comprises a tightening screw arranged on an external thread on the end section.

7. The cylinder according to claim 1, further including a first shaft end on a drive side of the hollow support shaft, and a second shaft end on an operating side of the hollow support shaft, wherein the hollow support shaft includes axial extensions arranged axially inwardly of the first and second shaft ends, respectively, each axial extension having a continuous recess in which the force transfer elements are respectively arranged.

8. The cylinder according to claim 7, further including a strain washer arranged on each axial extension between the force transfer elements and the respective tensioning element.

9. The cylinder according to claim 7, wherein a clearance space is defined on the drive side or the operating side shaft end, the clearance space extending radially between the support shaft and the operating mechanism, and further including a clamping sleeve arranged in the clearance space to be axially displaceable between, at one end, the energy-storage element and, at the other end, a shoulder on the operating mechanism.

10. The cylinder according to claim 1, further including fastening elements disposed in through openings in the operating mechanism, wherein the force transfer elements each include an inside bushing and an outside bushing that closes off the inside bushing in a radial direction toward the outside, the inside bushing being connected via the fastening elements to the operating mechanism.

11. The cylinder according to claim 10, wherein the clamping sleeve includes a radially outwardly directed recess in a region of the first force transfer element, the operating mechanism includes a radially outwardly directed recess in a region of the second force transfer element, and the inside bushing of the respective force transfer element projects into the respective recess.

12. The cylinder according to claim 7, wherein the first shaft end on the drive side of the hollow support shaft is positioned cantilevered and the second shaft end on the operating of the hollow support shaft includes a bearing that is removable from a support position.

13. A printing unit including the cylinder according to claim 12 and a housing, wherein the housing includes a pivotable bearing plate having one position in which the bearing plate supports the bearing, and another position in which the bearing plate is pivoted out of the housing, to a position on non-support for the bearing.

14. The printing unit according to claim 13, wherein the bearing plate includes a pivot journal about which the bearing plate is pivotable between the positions.

15. The cylinder according to claim 1, wherein the printing sleeve includes at each end an integral support ring and the tensioning elements are arranged between the support shaft and the respective support ring.

16. The cylinder according to claim 15, wherein the support rings include mounting recesses.

17. The cylinder according to claim 15, including at least one additional support element arranged between the hollow support shaft and the printing sleeve.

18. The cylinder according to claim 1, further including a centering sleeve arranged on the hollow support shaft between the two tensioning elements.

19. The cylinder according to claim 1, wherein the energy-storage element includes a set of spring washers.

20. A printing unit including the cylinder according to claim 2 and a housing, wherein the adjustment element is secured on the operating mechanism against axial movement, and the operating mechanism is connected to the hollow support shaft to rotate along, the printing unit further including a drive shaft arranged parallel to the hollow support shaft inside the housing and drive-connected to the hollow support shaft.

21. The printing unit according to claim 20, further including a displaceable holding element arranged on the housing and a device to accommodate the holding element arranged on the adjustment element.

22. The printing unit according to claim 21, wherein the device includes a number of pins arranged on a surface of the adjustment element that is facing the holding element.

23. The printing unit according to claim 21, wherein the holding element is adapted to be connected to a pneumatic cylinder.

24. The printing unit according to claim 23, and further including the pneumatic cylinder, the holding element being arranged on the pneumatic cylinder.

25. A method for replacing a printing sleeve arranged in a printing unit of a printing machine on a support shaft of the cylinder according to claim 2, wherein the cylinder is coupled to a drive, the method including:
initially shutting down the drive of the cylinder;
releasing a rotational connection between the printing sleeve and the support shaft, including adjusting the operating mechanism to relax the energy-storage element and the two tensioning elements;
pulling off the printing sleeve from the support shaft and removing the printing sleeve through an opening in a housing of the printing unit and thereafter pulling through the opening a different printing sleeve onto the support shaft, followed by closing off the opening; and
adjusting the adjustment element once more to tighten the energy-storage element and the two tensioning elements to clamp together the support shaft and the printing sleeve.

26. A method for replacing a printing sleeve arranged on a support shaft of a cylinder in a printing unit of a printing machine according to claim 20, wherein the drive shaft is coupled to a drive for driving the cylinder, the method including:
initially shutting down the drive of the cylinder;
following the shut-down of the drive, blocking the adjustment element to prevent rotation of the adjustment element;
starting the drive of the cylinder to rotate the support shaft and the operating mechanism a defined amount in a selected direction to adjust the operating mechanism for relaxing the energy-storage element and the two tensioning elements and thereby releasing a rotational connection between the printing sleeve and the support shaft;
shutting down the drive of the cylinder;
pulling off the printing sleeve from the support shaft and removing the printing sleeve through an opening in a housing of the printing unit and thereafter pulling through the opening a different printing sleeve onto the support shaft, followed by closing off the opening; and
adjusting the adjustment element once more to tighten the energy-storage element and the two tensioning elements to clamp together the support shaft and the printing sleeve so that the different printing sleeve rotates along with the support shaft.

27. The method according to claim 26, wherein the step of adjusting the adjustment element once more includes starting up again the drive of the cylinder to turn the support shaft and the operating mechanism counter to the previously selected direction of rotation to clamp the energy-storage element, the two tensioning elements and the printing sleeve onto the support shaft; shutting down the drive of the cylinder and unblocking the adjustment element to permit rotation of the adjustment element.
